(19) United States
(12) Patent Application Publication
(10) Pub. No.: US 2015/0239513 A1
(43) Pub. Date: Aug. 27, 2015

(54) Aerodynamic Semi-Trailer Fairing

(71) Applicant: Larry Lofton, Rancho Cucamonga, CA (US)

(72) Inventor: Larry Lofton, Rancho Cucamonga, CA (US)

(21) Appl. No.: 14/631,817

(22) Filed: Feb. 25, 2015

Related U.S. Application Data
(60) Provisional application No. 61/944,538, filed on Feb. 25, 2014.

(51) Int. Cl. B62D 35/02; B62D 35/00

(52) U.S. Cl. CPC B62D 35/02; B62D 35/001

(57) ABSTRACT

A fairing includes a prow portion having a pointed leading end adjacent an undercarriage and an aft trailing end. The trailing end extends across the undercarriage and vertically spans the space from the height of the undercarriage to the ride height of a vehicle. A support under the fairing resiliently maintains the prow portion in the shape of a boat hull prow, The fairing may present a curved boat hull shaped transition from the leading end to the trailing end, it may have chine spanning the prow portion from the leading end along a midpoint, or may be made of multiple panels and chines. The prow portion has vertical sides toward the trailing end, which terminate in vertical edges near the vehicle's tires. The fairing may include enlarged areas to increase aerodynamics near the tires, and may include scoops and a spoiler to help laminate turbulent air.

This application claims the priority benefit of provisional application No. 61/944,538, filed Feb. 25, 2014

### BACKGROUND

Vehicles, including semi-trailers, i.e., trailers without a front axle, are well known in the art. Due to the weight and size of tractor-trailer vehicles, operational fuel costs are high and efficient operation through proper tire pressure, engine maintenance and aerodynamics are paramount.

The fuel efficiency of tractor-trailer vehicles is influenced heavily by aerodynamics. Most of the power generated by a class 8 tractor for example, 50 to 70 percent, is used to overcome aerodynamic drag forces during operation at highway speeds of over forty five miles per hour. In addition to rooftop wind deflectors, aerodynamic mirrors and fairings have become standard equipment on modern tractor-trailer rigs.

Drag resulting from a semi-trailer's box shape severely impacts a tractor-trailer vehicle's overall wind resistance regardless of the aerodynamics of the tractor. Studies have shown that streamlining the front, rear and undercarriage of a rectangular vehicle can reduce fuel wasting drag by over 30 percent. For this reason, in addition to trailer fairings and rear box deflectors, semi-trailer skirts have been employed to decrease wind resistance.

Currently, semi-trailer skirts include two vertical members suspended from the undercarriage near the side walls of a semi-trailer. The vertical members form walls extending from just in front of the wheels along the undercarriage toward the rear wheels of a tractor. Typically the walls may be angled inward, or curve in slightly at the front of the semi-trailer to deflect more air.

One drawback of semi-trailer skirts as they are currently designed, is that turbulent air may enter between the skirts by travelling underneath a tractor and between the skirt members. The air passes between the skirts along the underside of the semi-trailer until it exits through the rear axles. The passage of air through this circuit can cause unwanted and unnecessary drag on the vehicle, lowering fuel economy.

For this reason there is a need for a semi-trailer skin that provides a more comprehensive guard against air travelling along the undercarriage of a semi-trailer. There is also a need for a semi-trailer skirt with increased aerodynamics to increase fuel efficiency. There is also a need for as semi-trailer skirt that equalizes air pressure between the underside of a semi-trailer and the outside air passing by the tractor-trailer vehicle.

### SUMMARY

A streamlining fairing for the undercarriage of a vehicle, such as a semi-trailer, includes a prow portion with a pointed leading end, adapted to rest adjacent the undercarriage, and a trailing end aft of the leading end. The trailing end horizontally spans approximately the entire undercarriage from a first side to an opposing second side, the trailing end also vertically spans a space approximately from the height of the undercarriage to a ride height of the vehicle.

A support resiliently maintains the prow portion in the shape of a boat hull prow. Due to the shape of the fairing, it spoils turbulent air encountering the fairing and directs it around the undercarriage of the vehicle. Ideally the prow portion is made of a material having a smooth surface texture for increased drag reduction.

In mimicking a boat hull prow shape, the fairing's prow portion may present a curved transition from the leading end toward the trailing end. If not entirely smooth, the fairing may has chine spanning the prow portion from the leading end to a midpoint of the trailing end, as resembles most boat hulls. In the alternative, the prow portion may be made of panels and multiple chines that together establish the boat hull prow shape.

To press air out from under the undercarriage, the prow portion may vertical sides, particularly toward the trailing end. To maintain even air pressure and decrease turbulence, vertical sides may have one or more air scoops. Preferably the trailing end terminates in vertical edges serving as walls complimentary to the vehicle's vertical walls to hold air away from the undercarriage. In some instances, the trailing end may include vertical panels that extend aft of a horizontal bottom edge of the trailing end.

The trailing end may also have arced vertical edges shaped to accommodate the curvature of as vehicle tire, allowing the fairing to be placed very close to the tires. Due to the size of the tire assemblies typically used on a semi-trailer, the prow portion may have enlarged areas adjacent the trailing end to push air farther out beyond the fairing. Some air will inevitably travel under the fairing while a vehicle is motion. To help smooth out air pushed under the fairing, the trailing end may include a spoiler along its horizontal edge.

### BRIEF DESCRIPTION OF THE FIGURES

FIG. 1 is as perspective view of a vehicle fairing having a prow portion with chines and panels.

FIG. 2 is a perspective of the fairing having a smooth prow portion.

FIG. 3 is a side view of the fairing in an upright orientation for installation.

FIG. 4 is a perspective view of the fairing installed on a vehicle undercarriage.

FIG. 5 is a right side perspective view of the fining installed on the undercarriage.

FIG. 6 is a left side perspective view of the fairing installed on the undercarriage.

### REFERENCE NUMBERS

10. fairing
12. vehicle
14. undercarriage
16. prow portion
18. leading end
20. trailing end
22. first side of the undercarriage
24. second side of the undercarriage
26. ride height
28. support
30. curved transition
32. chine
34. midpoint
36. panels
38. vertical sides
40. scoop
44. vertical edges
46. vertical panels
48. bottom edge
50. arced vertical edges
52. vehicle tire
54. enlarged areas
56. spoiler

### DESCRIPTION

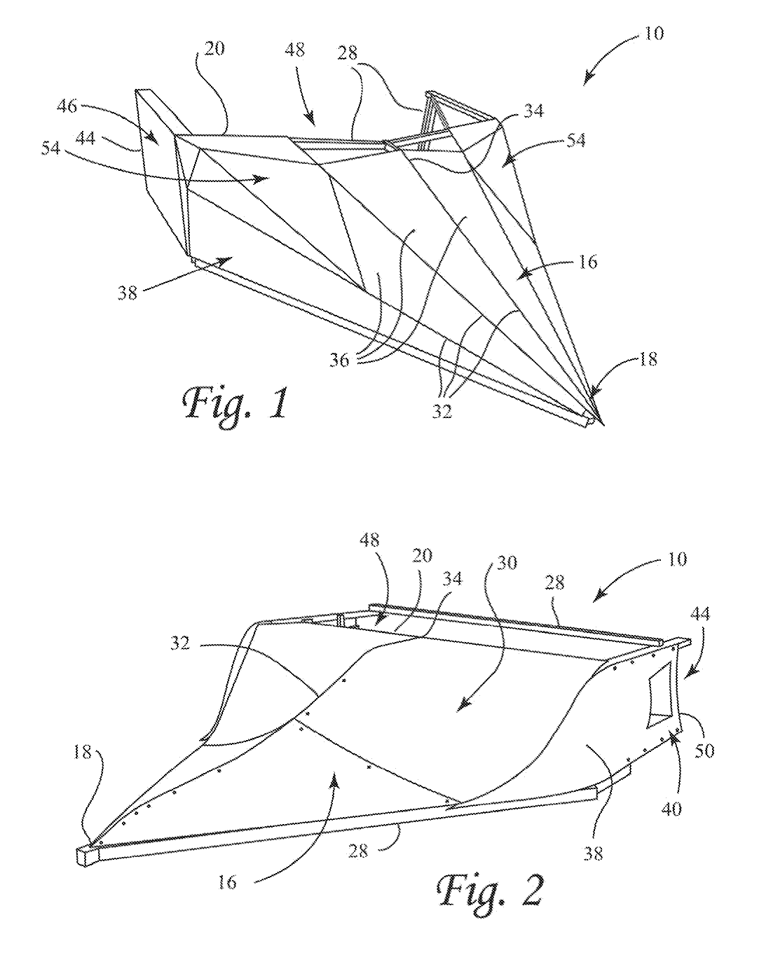

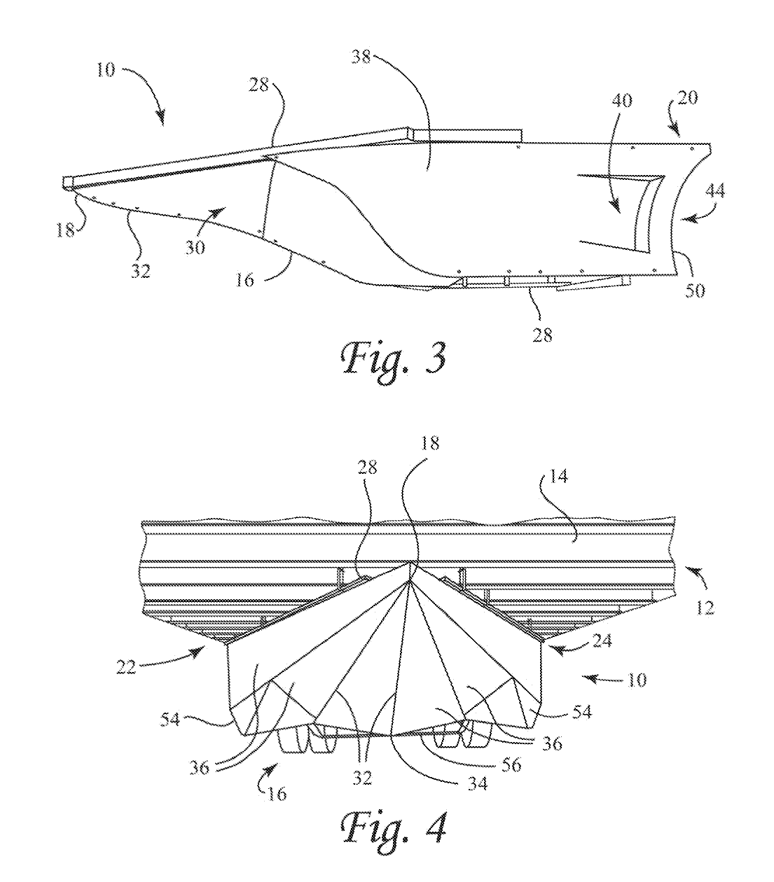

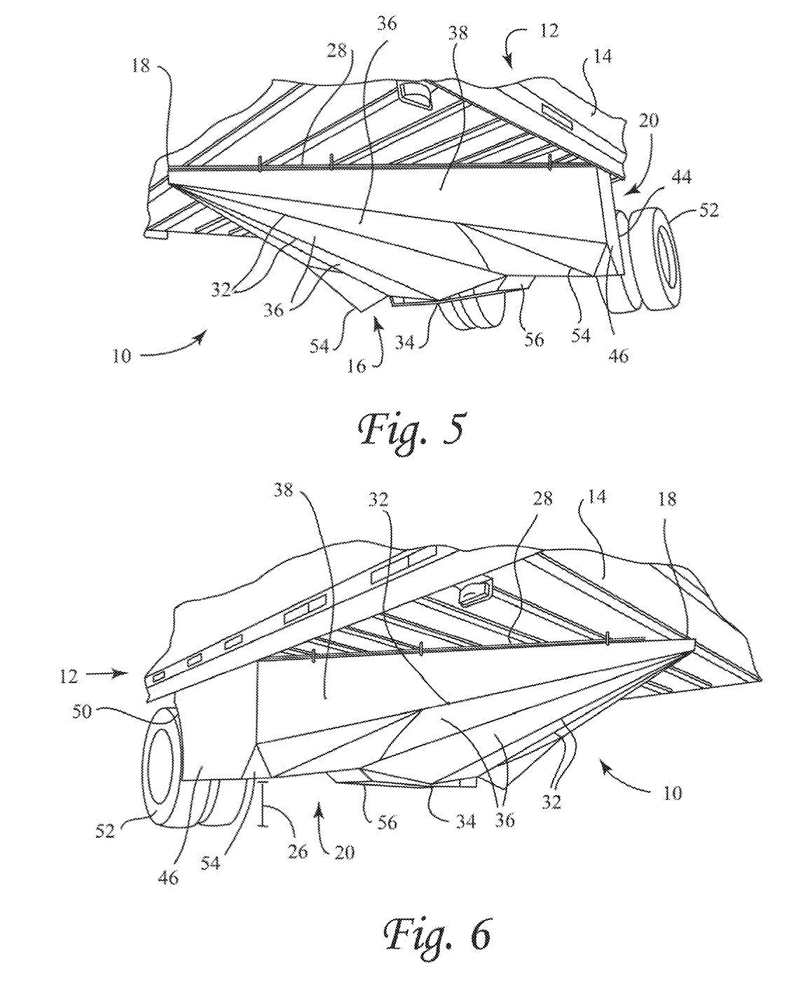

Referring to FIGS. 1-6, an improved fairing 10 particularly suited for towed vehicles 12, such as semi-trailers, can he attached to a vehicle 12 undercarriage 14. The fairing 10 includes a prow-shaped, forward-facing prow portion 16, having a pointed leading end 18 similar to the prow of a boat. The prow portion 16 preferably installs so that the leading end 18 is adjacent to the undercarriage 14.

The prow portion 16 also includes a trailing end 20 opposite the leading end 18 horizontally spanning the undercarriage 14 from a first side 22 of the undercarriage 14 to an opposing second side 24 (see FIG. 4). The term “side” in this context should be understood to he a side of the vehicle 12 as it moves in a direction of travel (i.e., the sides as opposed to the front or rear of the vehicle 12 and its undercarriage 14).

The trailing end 20 also has a height, vertically spanning a space approximately from the undercarriage 14 to the ride height 26 of the vehicle 12. The ride height 26 is the clearance of the vehicle 12 from a road surface, including any statutorily required clearance depending on the vehicle's 12 class. The term “approximately” should be interpreted as at or near the distance between the undercarriage 14 and the ride height 26. Preferably the height of the trailing end 20 is slightly less than the ride height 26 to avoid contact with a road surface.

A support 28 coupled to the prow portion 16 holds the prow portion 16 in position and maintains its shape under wind pressure while in motion. The support 28 may connect the fairing 10 to the undercarriage 14, and ideally maintains the prow portion 16 in the shape of a boat hull prow, causing the fairing 10 to spoil turbulent air as it encounters the fairing 10 and directing it around the vehicle 12. It is anticipated that the support 28 may also be simply the material comprising the prow portion 16, such as fiberglass, and in this manner, the support mechanism and prow portion 16 are synonymous, requiring only fixing structures (not shown) fur attaching the fairing 10 to a vehicle 12.

The prow portion 16 may have a smooth curvature 30 from the leading end 18 to the trailing end 20. The smooth curvature 30 may also be bisected by a chine 32 traveling from the leading end 18 to a midpoint 34 of the trailing end 20, accentuating its resemblance to a boat hull prow. Alternatively, the prow portion 16 may have multiple chines 32 connected by panels 36, including flat panels, that together make up the prow portion's 16 boat hull prow shape.

Because the sides of large vehicles 12, including semi-trailers, are flat, and to avoid encouraging air to travel under the vehicle 12, the prow portion 16 may have vertical sides 18 in areas toward the trauma end 20. In some embodiments, the vertical sides 38 may include one or more scoops 40 to spoil turbulent air and equalize air pressure on either side of the fairing 10. Preferably the trailing end 20 includes vertical edges 44 even if the majority of the prow portion 16 does not, to conform to tires 52 of the vehicle 12 or additional semi-trailer skirting as is currently known in the art.

The trailing end 20 may include vertical panels 48 that extend aft of a horizontal bottom edge 48 of the trailing end 20. The vertical panels 46 help perform the function of the aforementioned semi-trailer skirts, and allow the trailing end 20 of the fairing 10 to be installed close to the tires 52 of the vehicle 12. The trailing end 20 may also have arced vertical edges 50 shaped to accommodate the curvature of a tire 52, allowing the fairing to maximize vehicle 12 streamlining.

Due to pressure created by the fairing 10 and given the size of tire 52 assemblies on a vehicle 12 such as a semi-trailer, the fairing 10 may include enlarged areas 54 adjacent the trailing end 20 to help push air away from the approaching tires 52 and reduce drag. In some instances, the enlarged areas 54 may exceed the ride height 26, even though the rest of the prow portion 16 does not.

Although most of the air traveling past the fairing 10 will be shunted to the sides of the undercarriage 14, some quantity of air will also travel under the fairing 10 resulting in increased turbulence. To help laminate turbulent air as it travels under the fairing 10 a spoiler 56 may be installed along the horizontal bottom edge 48, preferably near the midpoint 14 of the trailing end 20.

The shape of the fairing 10 directs the flow of air to the side and away from vehicles 12 such as a semi-trailer. It also directs air drawn in behind the front wheels (not shown) of a tow tractor (not shown) by vacuum pressure away from the underside and trailing wheels 52 of a semi-trailer.

Wind resistance against tractor-trailers causes air movement over the top and sides of the cab (not shown), as well as under the cab when in motion. Turbulent air emerging from under the cab encounters the fairing 10 which smoothes out the air flow. The enlarged areas 54 help split air travelling behind the cab to smoothly pass under the fairing 10 and around the side of the fairing 10.

While the foregoing description is sufficient in detail to enable one skilled in the art to make and use the invention, it should be understood, however that the detail of the preferred embodiments presented is not intended to limit the scope of the invention. Therefore equivalents thereof and other modifications which come within the scope of the invention as defined by the claims will become apparent to those skilled in the art upon reading this specification.

I claim:

1. An aerodynamic semi-trailer fairing substantially as shown and described.
